(19) United States
(12) Patent Application Publication
(10) Pub. No.: US 2019/0135360 A1
(43) Pub. Date: May 9, 2019

(54) TRANSVERSE BAR FOR TRACKS OF SNOW GROOMERS

(71) Applicant: PRINOTH S.P.A., Vipiteno (IT)

(72) Inventors: Riccardo Spandoni, Modena (IT); Gregor Maurer, Vipiteno (IT)

(21) Appl. No.: 16/096,140

(22) PCT Filed: Apr. 27, 2017
(86) PCT No.: PCT/IB2017/052444

§ 371 Date: Oct. 24, 2018

(30) Foreign Application Priority Data
Apr. 27, 2016 (IT) 102016000043036

(51) Int. Cl. B62D 55/28; B62D 55/253

(52) U.S. Cl. CPC B62D 55/286; B62D 55/253

(57) ABSTRACT

A transverse bar for tracks of snow groomers is defined by a section bar and by covering plates fixed to the section bar, which is delimited by an outer surface and comprises a fixing portion to fix the transverse bar to the belts of a track of a snow groomer, and two lateral sides projecting from the fixing portion; the covering plates being arranged along the lateral sides so as to define part of an outer surface of the transverse bar.

### PRIORITY CLAIM

This application is a national stage application of PCT/IB2017/052444, filed on Apr. 27, 2017, which claims the benefit of and priority to Italian Patent Application No. 102016000043036, filed on Apr. 27, 2016, the entire contents of which are each incorporated by reference herein.

### TECHNICAL FIELD

The present disclosure relates to a transverse bar for tracks of snow groomers.

### BACKGROUND

In the field of preparation of ski slopes, it is known to provide a snow groomer comprising a support frame, a driver's cabin mounted centrally on the support frame, and two tracks mounted on opposite sides of said support frame.

Each track comprises a set of wheels rotatably mounted on the support frame; a plurality of belts looped around the wheels; and a plurality of transverse bars fixed to the belts transversely to the forward direction of the track and configured to enable the gripping of the track itself to the snow of the ski slope.

Each transverse bar comprises a section bar, which is normally made of steel, aluminium or aluminium alloy, has a contoured shape, and is bounded by an outer surface having a substantially triangular shape.

The outer surface comprises a fixing portion, which is substantially flat and arranged in contact with a number of belts, which depends on the length of the transverse bar, and two lateral sides which project from the fixing portion and converge with each other.

The transverse bar also has an inner cavity, which extends through the section bar transversely to the forward direction of the track and is laterally open at its free ends.

The transverse bar is covered with an outer covering, which is applied at least in the area of the two lateral sides, is normally made of aluminium or aluminium alloy, and is applied on the transverse bar to prevent the snow and/or ice from adhering to the transverse bar and improve the gripping capacity of the track to the ground.

The snow groomer is also equipped with a plurality of operating units, such as for example a milling cutter for processing the snow of the ski slopes, a shovel for moving snow masses along the ski slopes, and/or a winch assembly to ensure the stability of the snow groomer on relatively steep slopes and prevent slipping of the snow groomer if the snow groomer loses adherence to the snow.

The known transverse bars for tracks of snow groomers of the type described above have a few drawbacks mainly resulting from the outer covering being subject to scratches and tears, and therefore has a relatively limited effectiveness.

### SUMMARY

The object of the present disclosure is to provide a transverse bar for tracks of snow groomers, which is free from certain of the drawbacks described above and relatively simple and economical to implement.

According to the present disclosure, a transverse bar for tracks of snow groomers is provided, the transverse bar comprising a section bar and covering plates fixed to the section bar, which is delimited by an outer surface and comprises a fixing portion to fix the transverse bar to the belts of a track of a snow groomer and two lateral sides projecting from the fixing portion; wherein the covering plates are arranged along the lateral sides so as to define part of an outer surface of the transverse bar. In this way, it is possible to select materials for the manufacturing of the plates, which enable for obtaining a smooth surface that minimizes snow adhesion.

In particular, each covering plate is substantially flat and arranged on a flat portion of the section bar so as to facilitate the coupling between the section bar and the covering plates.

In particular, the covering plate is made of a polymer material selected in the group consisting of low-density polyethylene, high-density polyethylene, polyamide, polypropylene, acetal resins, polycarbonate, fluoropolymers (in particular, polytetrafluoroethylene), and derivatives thereof with additives and/or fillers. The materials listed above have proven to be particularly effective in limiting snow adhesion.

Additional features are described in, and will be apparent from the following Detailed Description and the figures.

### BRIEF DESCRIPTION OF THE DRAWINGS

The present disclosure will now be described with reference to the accompanying drawings, which illustrate a non-limiting embodiment thereof, in which:

FIG. 1 is a schematic side view, with parts removed for clarity, of an embodiment of the snow groomer of the present disclosure;

FIG. 2 is a schematic plan view, with parts removed for clarity, of a detail of the snow groomer of FIG. 1;

FIG. 3 is a schematic perspective view, with parts removed for clarity, of a detail of FIG. 2; and

FIG. 4 is a schematic perspective view, with parts removed for clarity, of a variant of the detail of FIG. 3.

### DETAILED DESCRIPTION

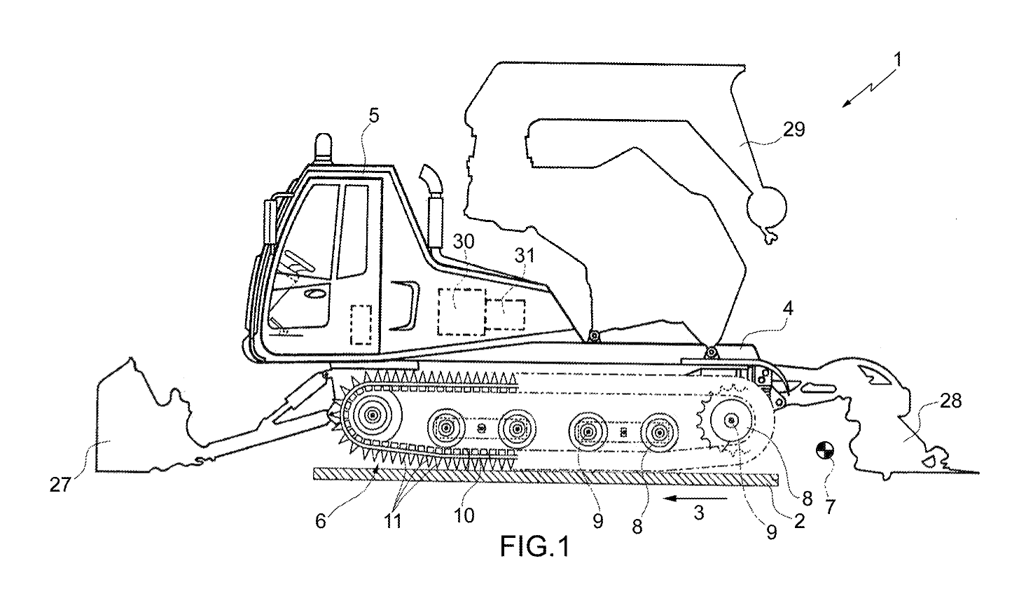

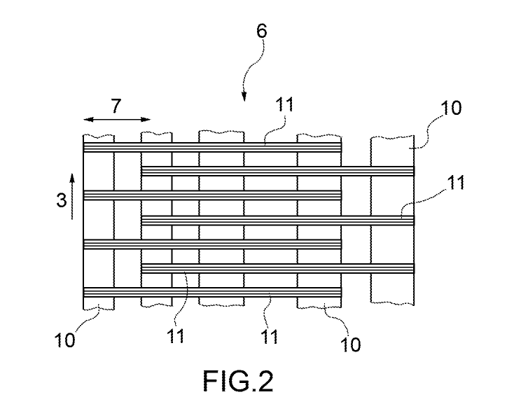

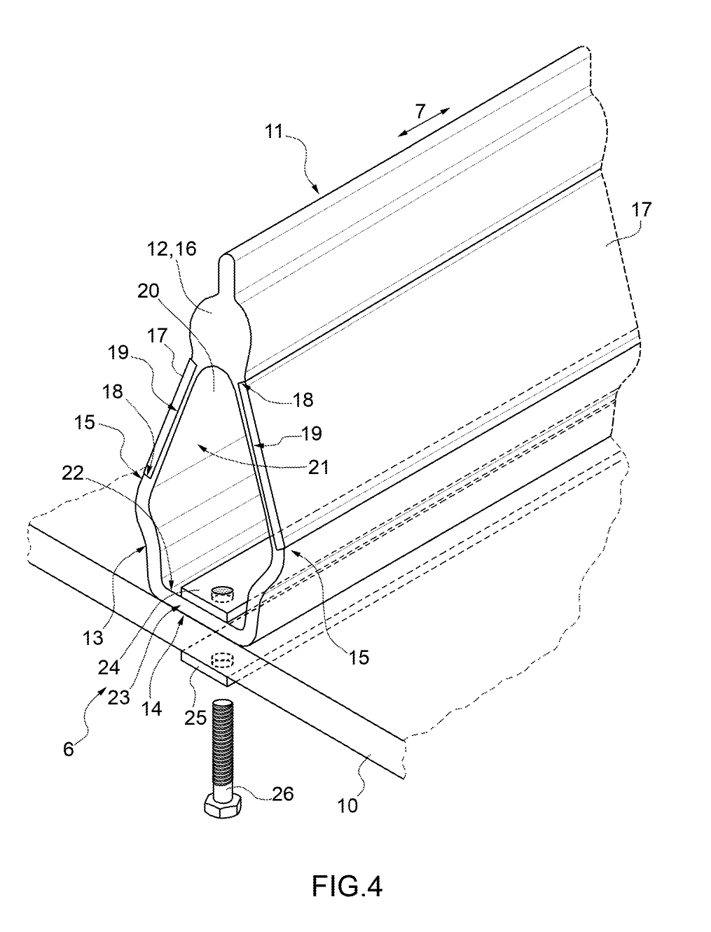

Referring now to the example embodiments of the present disclosure illustrated in FIGS. 1 and 4, with reference to FIGS. 1 and 2, the numeral 1 indicates, as a whole, a snow groomer for the preparation of ski slopes 2.

The snow groomer 1 is motorised so as to move along a slope 2 in a forward direction 3, and comprises a support frame 4, a driver's cabin 5 mounted centrally on the frame 4, and two tracks 6 (only one of which is shown in FIG. 1) mounted on opposite sides of the frame 4 in a direction 7 transverse to direction 3 and perpendicular to the plane of the sheet of FIG. 1.

Each track 6 comprises a set of wheels 8 mounted on the frame 4 so as to rotate about respective rotation axes 9 parallel to direction 7, and a plurality of belts 10 movable in respective vertical containment planes parallel to each other and perpendicular to said direction 7.

Each belt 10 is looped around the front wheel 8 and the rear wheel 8, and has a lower branch, which is kept in contact with the slope 2 by the intermediate wheels 8.

The track 6 also comprises a plurality of transverse bars 11, which are fixed to the respective belts 10 parallel to direction 7, and are configured to enable the gripping of said track 6 to the snow of the ski slope 2.

Each bar 11 comprises a section bar 12, which is in certain embodiments, but not necessarily, made of steel, aluminium or aluminium alloy, has a contoured shape, and is bounded by an outer surface 13 having a substantially triangular shape.

The surface 13 comprises a fixing portion 14, which is substantially flat and arranged in contact with a number of belts 10, which depends on the length of the bar 11, and two lateral sides 15, which project from the portion 14, converge with each other, and are connected to one another at an end portion 16 of the section bar 12 opposite the portion 14 itself.

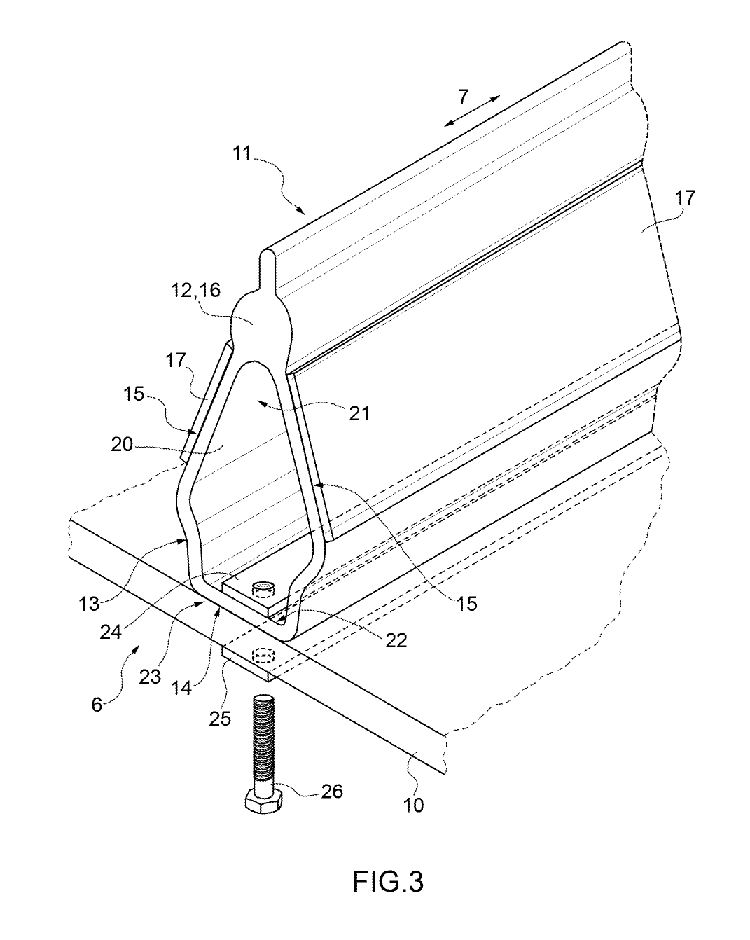

As shown in FIG. 3, the bar 11 also comprises, on each side 15, a respective flat covering plate 17 fixed to a corresponding flat portion of the side 15 itself.

The plate 17 is made of a polymer material selected in the group consisting of low-density polyethylene, high-density polyethylene, polyamide, polypropylene, acetal resins, polycarbonate, fluoropolymers (in particular, polytetrafluoroethylene), and derivatives thereof with additives and/or fillers. In this case, the plate 17 extends along the entire side 15 in direction 7, and has a substantially parallelepiped shape.

The plate 17 has, perpendicular to said direction 7, a rectangular cross section, and also has a thickness at least equal to 0.1 mm.

The plate 17 is fixed to the side 15 by gluing and/or fastening screws (not shown) or is directly manufactured through moulding on the side 15 itself.

The variant shown in FIG. 4 differs from what shown in the preceding figures solely in that, therein, each plate 17 is housed within a respective cavity 18, which is formed on the corresponding side 15 and is bounded by a bottom wall 19 that is substantially flat.

The plate 17 is coplanar with the surface 13 and is fixed within the cavity 18 by gluing and/or fastening screws (not shown) or is directly manufactured through moulding within the cavity 18 itself

According to some variants (not shown):
each plate 17 of at least part of the bars 11 extends only along part of the respective side 15;
each plate 17 has, perpendicular to direction 7, a cross section substantially having the shape of a trapezoid with inclined lateral sides, which facilitate the removal of snow and/or ice from the respective bar 11; and
each cavity 18 has a cross section substantially having the shape of a trapezoid with inclined lateral sides configured so as to lock the respective plate 17 inside said cavity 18 perpendicularly to the respective bottom wall 19.

In connection with the above, it should be pointed out that the plates 17 of each section bar 12 therefore define, both in the embodiment shown in FIG. 3 and in the embodiment shown in FIG. 4, part of the outer surface of the respective bar 11.

Each bar 11 also has an inner cavity 20, which extends through the section bar 12 in direction 7 and is laterally open in direction 7.

The cavity 20 is bounded by an inner surface 21 comprising a substantially flat coupling portion 22 parallel and opposite to the portion 14 of the surface 13.

The bar 11 is fixed to the respective belts 10 by a fixing device 23 comprising, in this case, an inner plate 24 inserted within the cavity 20 in contact with the portion 22, and an outer plate 25 arranged in contact with the respective belts 10 on the opposite side of the section bar 12.

The assembly defined by the plates 24 and 25, the belts 10 and the bar 11 is locked perpendicular to the portions 14 and 22 by a plurality of fastening screws 26 mounted through the plate 25, the belts 10 and the section bar 12 and screwed into the plate 24.

The snow groomer 1 is also provided with a shovel 27 connected to the front of the frame 4 to move snow masses along the slope 2, a milling cutter 28 connected to the rear of the frame 4 configured to process the snow of the slope 2, and a winch assembly 29 mounted above the frame 4 itself.

The snow groomer 1 also comprises an internal combustion engine 30 connected with at least one of the front and rear wheels 8, the shovel 27, the milling cutter 28 and the winch assembly 29 by a transmission unit 31 of a known type.

The polymeric material used to manufacture the plates 17 enables for obtaining a relatively reduced roughness and a relatively high surface finish. Experimental tests have shown that the polymeric material plates 17 inhibit the adhesion of snow and/or ice to the bars 11.

Finally, it is evident that modifications and variants can be made with regard to the disclosure thus described without departing from the scope of the appended claims. As such, the present disclosure also covers embodiments not described in the detailed description and equivalent embodiments that fall within scope of the appended claims. Accordingly, various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1-11. (cancelled)

12. A snow groomer track transverse bar comprising:
a section bar delimited by an outer surface, defining an elongated shape and extending in a first direction, the section bar comprising:
a fixing portion to fix the section bar to a plurality of belts of a track of a snow groomer, and
two lateral sides projecting from the fixing portion; and
a plurality of covering plates fixed to the section bar, wherein:
each covering plate has a length, measured parallel to the first direction, that is substantially equal to a length of the snow groomer track transverse bar measured parallel to the first direction,
the covering plates are arranged along the lateral sides to define part of an outer surface of the snow groomer track transverse bar, and
each covering plate is made of a polymer material selected from the group consisting of: a low-density polyethylene, a high-density polyethylene, a polyamide, a polypropylene, at least one acetal resin, a polycarbonate, and at least one fluoropolymer.

13. The snow groomer track transverse bar of claim 12, wherein each covering plate is substantially flat and is arranged on a flat portion of the section bar.

14. The snow groomer track transverse bar of claim 12, wherein each covering plate has, perpendicularly to the first direction, a substantially rectangular cross section.

15. The snow groomer track transverse bar of claim 12, wherein each covering plate has, perpendicularly to the first direction, a cross section substantially defining a shape of a trapezoid with inclined lateral sides.

16. The snow groomer track transverse bar of claim 12, wherein each covering plate has, perpendicularly to the first direction, a cross section substantially defining a shape with an inclined lateral side.

17. The snow groomer track transverse bar of claim 12, wherein each covering plate is fixed to a relative one of the lateral sides by at least one of: gluing and at least one fastener.

18. The snow groomer track transverse bar of claim 12, wherein each covering plate is moulded on a relative one of the lateral sides.

19. The snow groomer track transverse bar of claim 12, wherein each lateral side defines a housing cavity, which opens up outwards and is configured to house, on an inside, one of the covering plates.

20. The snow groomer track transverse bar of claim 19, wherein an outer face of the covering plate is substantially coplanar with the outer surface of the section bar.

21. The snow groomer track transverse bar of claim 12, wherein the section bar defines an inner cavity which extends through the section bar in the first direction and is laterally open in that first direction.

22. The snow groomer track transverse bar of claim 12, wherein each covering plate has a thickness that is at least equal to 0.1 mm.

23. The snow groomer track transverse bar of claim 12, wherein the at least one fluoropolymer comprises a polytetrafluoroethylene.

24. The snow groomer track transverse bar of claim 12, wherein the polymer material comprises at least one of an additive and a filler.

25. A snow groomer comprising:
a support frame;
a driver cabin fitted on the support frame; and
two tracks fitted on opposite sides of the support frame, each track comprising:
a plurality of parallel belts, and
a plurality of transverse bars fixed to the belts, each transverse bar comprising:
a section bar delimited by an outer surface, defining an elongated shape and extending in a first direction, the section bar comprising:
a fixing portion, and
two lateral sides projecting from the fixing portion; and
a plurality of covering plates fixed to the section bar, wherein:
each covering plate has a length, measured parallel to the first direction, that is substantially equal to a length of that transverse bar measured parallel to the first direction,
the covering plates are arranged along the lateral sides to define part of an outer surface of that transverse bar, and
each covering plate is made of a polymer material selected from the group consisting of: a low-density polyethylene, a high-density polyethylene, a polyamide, a polypropylene, at least one acetal resin, a polycarbonate, and at least one fluoropolymer
